(19) United States
(12) Patent Application Publication
(10) Pub. No.: US 2017/0110025 A1
(43) Pub. Date: Apr. 20, 2017

(54) INTEGRATED SYSTEM AND METHOD FOR CHANGING A PATTERN OF WATER CONSUMPTION THROUGH GAMIFICATION

(71) Applicants: Ali Abbasi Talaei, Shahroud (IR); Sobhan Abdolmaleki, Ardabil (IR)

(72) Inventors: Ali Abbasi Talaei, Shahroud (IR); Sobhan Abdolmaleki, Ardabil (IR)

(21) Appl. No.: 15/393,141

(22) Filed: Dec. 28, 2016

(30) Foreign Application Priority Data
Dec. 28, 2015 (IR) 13945014000301103

(51) Int. Cl. G09B 19/00; G09B 5/02; G08B 21/18; G06Q 50/06

(52) U.S. Cl. CPC G09B 19/00; G06Q 50/06; G09B 5/02; G08B 21/182

(57) ABSTRACT

A system for controlling water consumption of a consumer through gamification is disclosed. The system may include, among others, a main power supply, a processing device, a display device, and an electrical valve. The main power supply may be configured to produce electricity for the system located within a facility of a consumer. The processing device may be configured to receive input data associated with water consumption of the consumer and calculate output data based on the received input data. The output data may include water consumption amount of the consumer, cost associated with the water consumption amount, a target consumption level for the consumer, and a consumer consumption level ranking with reference to consumption level of other consumers. The display device may be configured to display the output data to the consumer. The electrical valve may be configured to disconnect or connect water supply to the facility based on the calculated output data.

### CROSS REFERENCE TO RELATED APPLICATION

This application claims the benefit of priority to an Iran patent application having serial number 139450140003011036 filed on Dec. 28, 2015, which is incorporated by reference herein in its entireties.

### TECHNICAL FIELD

The instant application relates generally to a system for changing human behavioral patterns through gamification and, more particularly, to an integrated system and method for changing a pattern of water consumption through gamification of a smart digital water display.

### BACKGROUND

Water is one of the most precious resources on our planet. In many parts of the today's world, there is a serious problem of water scarcity and water shortage. Water shortage crisis is a critical issue and lack of proper management of optimal use of water resources can cause excessive consumption of this precious resource. One reason for excessive water consumption by consumers (e.g., individuals, households, industries, agricultural establishments, etc.), is lack of knowledge among consumers about their consumption amount in comparison with other consumers and the associated cost. Another reason for excessive water consumption can be lack of feedback with respect to the consumption amount.

Various studies suggest that receiving feedbacks related to human behavior can help individuals to change their behavioral patterns. Therefore a need exists for a system to provide feedback information and statistics related to water consumption to consumers in order to change excessive water consumption patterns among the consumers.

### SUMMARY

In one general aspect, the instant application describes a system for changing pattern of water consumption of a consumer through gamification. The system includes a power supply configured to produce electricity for the system; a processor configured to receive input data associated with water consumption of the consumer, wherein the input data includes consumer type, meter data, date, time, and a water fee, and calculate output data, wherein the output data includes, water, consumption amount of the consumer, cost of the consumption amount, standard consumption level for the consumer, consumer ranking, and consumption level of other consumers similar to the consumers; a display monitor configured to display output data to the consumer; a memory unit configured to temporarily store the input data and the output data; a data storage unit configured to permanently store the input data and the output data; a radio service unit configured to provide communication between the system and a server; an identity module configured to hold identity data of the consumer and communicate the identity data with the server; and an electrical valve configured to disconnect or connect water supply to the consumer based on the calculated output data.

The above-mentioned and other general aspects may include one or more of the following features. For example, the system may include a backup batter configured to produce electricity for the system when the power supply is unavailable. The display monitor can be a touch screen enabling the consumer to interact with the system. The radio service unit can provide wireless communication between the system and the server. The consumer type may include a household, an industry, an agricultural facility, or a combination thereof. The consumption level of other consumers similar to the consumers can be displayed on the display monitor based on a permission from other consumers. The output data can be provided to the consumer via the display monitor in real time. The radio service unit can send the input data, the output data or a combination thereof to the server. The processor may be configured to generate a warning of excessive water consumption based on the input data, the output data, or a combination thereof, and send the warning to the consumer via the display monitor. The processor may be further configured to activate the electrical valve to disconnect or connect water supply to the consumer. The data storage unit can be external to the system.

In another general aspect, the instant application describes a method for changing pattern of water consumption of a consumer through gamification. The method includes receiving input data associated with water consumption of the consumer, wherein the input data includes consumer type, meter data, date, time, and a water fee; calculating output data, wherein the output data includes, water consumption amount of the consumer, cost of the consumption amount, standard consumption level for the consumer, and consumption level of other consumers similar to the consumers; displaying output data to the consumer via a display monitor; storing the input data, the output data or a combination thereof in a data storage unit; and sending the input data, the output data or a combination thereof to a server via a radio service unit.

The above-mentioned and other general aspects may include one or more of the following features. For example, the method may include disconnecting water supply to the consumer using an electrical valve, based on the calculated output data. The display monitor can be a touch screen enabling the consumer to input data. The radio service unit can provide wireless communication between a consumer device and the server. The consumer type may include a household, an industry, an agricultural facility, or a combination thereof. The consumption level of other consumers similar to the consumers can be displayed on the display monitor based on a permission from other consumers. The output data can be provided to the consumer via the display monitor in real time. The method may further include generating a warning of excessive water consumption, based on the input data, the output data, or a combination thereof; and sending the warning to the consumer via the display monitor. The method may further include activating the electrical valve to disconnect water supply to the consumer.

### BRIEF DESCRIPTION OF THE DRAWINGS

Features of the subject technology are set forth in the appended claims. However, for purpose of explanation, several implementations of the subject technology are set forth in the following figures.

FIG. 1 illustrates a diagram of a power supply of an integrated system and method for changing a pattern of water consumption through gamification of a smart digital water display, according to one implementation;

FIG. 2 illustrates a diagram of a processor of an integrated system and method for changing a pattern of water consumption through gamification of a smart digital water display, according to one implementation;

FIG. 3 illustrates a diagram of a display unit of an integrated system and method for changing a pattern of water consumption through gamification of a smart digital water display, according to one implementation;

FIG. 4 illustrates a diagram of a dynamic memory of an integrated system and method for changing a pattern of water consumption through gamification of a smart digital water display, according to one implementation;

FIG. 5 illustrates a diagram of a data storage unit of an integrated system and method for changing a pattern of water consumption through gamification of a smart digital water display, according to one implementation;

FIG. 6 illustrates a diagram of a radio service unit of an integrated system and method for changing a pattern of water consumption through gamification of a smart digital water display, according to one implementation;

FIG. 7 illustrates a diagram of connection between a radio service unit and an identity module of an integrated system and method for changing a pattern of water consumption through gamification of a smart digital water display, according to one implementation;

FIG. 8 illustrates a diagram of a control unit of an integrated system and method for changing a pattern of water consumption through gamification of a smart digital water display, according to one implementation;

FIG. 9 illustrates a diagram of a backup battery connection for an integrated system and method for changing a pattern of water consumption through gamification of a smart digital water display, according to one implementation; and

FIG. 10 is a simplified functional block diagram of an exemplary personal computer or customer device that may be used by an integrated system and method for changing a pattern of water consumption through gamification of a smart digital water display, according to an implementation.

### DETAILED DESCRIPTION

In the following detailed description, numerous specific details are set forth by way of examples in order to provide a thorough understanding of the relevant teachings. However, it should be apparent to those skilled in the art that the present teachings may be practiced without such details. In other instances, well-known methods, procedures, components, and/or circuitry have been described at a relatively high-level, without detail, in order to avoid unnecessarily obscuring aspects of the present teachings.

Amid ongoing environmental changes on planet earth, water shortage and scarcity has become a major issue in many parts of the world. In addition to shortage of natural resources in general, mismanagement of water resource and lack of proper planning for optimal water usage in various sectors of the society have given rise to improper distribution of the resource among various consumers.

Some of the factors that may cause excessive water use are lack of knowledge and immediate feedback among consumers (e.g., individuals, households, industries, agricultural establishments, etc.), about their consumption amount and the associated cost. In fact, if the consumers are provided with their consumption amount and comparison between those amounts with consumption amounts of other similar consumers, they may be encouraged to question their consumption patterns and may be able to better manage their water consumption level.

On the other hand, feedback on behavioral patterns can be an efficient way for improving behavior. For example, if the consumers can see their daily, weekly, monthly or annual water consumption via a display monitor and to compare their consumption with a standard consumption level, the feedback and comparison can educate the consumers and help individual consumers or groups of consumers to revisit and revise their consumption patterns and decrease the consumption to the standard level. The integrated system and method for changing a pattern of water consumption through gamification can provide data to the consumer in real time, such that, for example, the consumer can be informed of their behavioral patterns and learn how various behaviors and activities can affect their water consumption level.

Modification of water consumption patterns among the consumers requires a system to be designed and implemented to motivate consumers to take voluntarily actions towards the behavioral change. Measures such as monetary penalties and fines have been proved not to be effective in encouraging the consumers to reduce water consumption. However, in modern world various interactive and motivational methods have been suggested for changing human behavior. One of such methods is gamification. According to the Gamification theory, game-related principles, particularly those relating to user experience and engagement, can be applied to non-game contexts such as education.

In recent years, various game initiatives have been established to explore the application of game principles to public policy issues. From that initiative, gamification for education emerged and gradually evolved into a field of study. Today, many game researchers have extended serious advancements in the application of gamification (or “gameful thinking”) to educational contexts. For example, designing water meters based on gamification concept can provide a baseline for contribution and competition among consumers and it can result in a modification in water consumption patterns and culture in long term.

Gamification of water consumption can enter the consumers into an attractive competition and interaction with others via which they can share their actions with each other and compete towards reduction in their water consumption. Public participation in such initiatives can result in a fundamental change in water consumption behavior in the society and among various groups of consumers.

The disclosed integrated system and method for changing pattern of water consumption through gamification, provides a smart digital water display to present a visual representation of the water consumption pattern to the consumer. For example, the smart digital water display can be installed anywhere within a home, factory, workshop, farm, office, etc. and the consumers can see a graphical representation of their water consumption. The consumers are also able to compare their consumption with other similar consumers.

The integrated system and method for changing pattern of water consumption through gamification can also provide warnings to the consumer when their consumption exceeds allowed levels and can also disconnect the delinquent consumer's water supply after a number of warnings. The disconnection can be done by installing an electric valve on the input supply pipe.

The integrated system and method for changing pattern of water consumption through gamification can communicate with a server, for example using wireless General Packet Radio Service (GPRS) technology, and send consumption data to the server for further use such as billing. The consumers can see their consumption data on the smart digital water display.

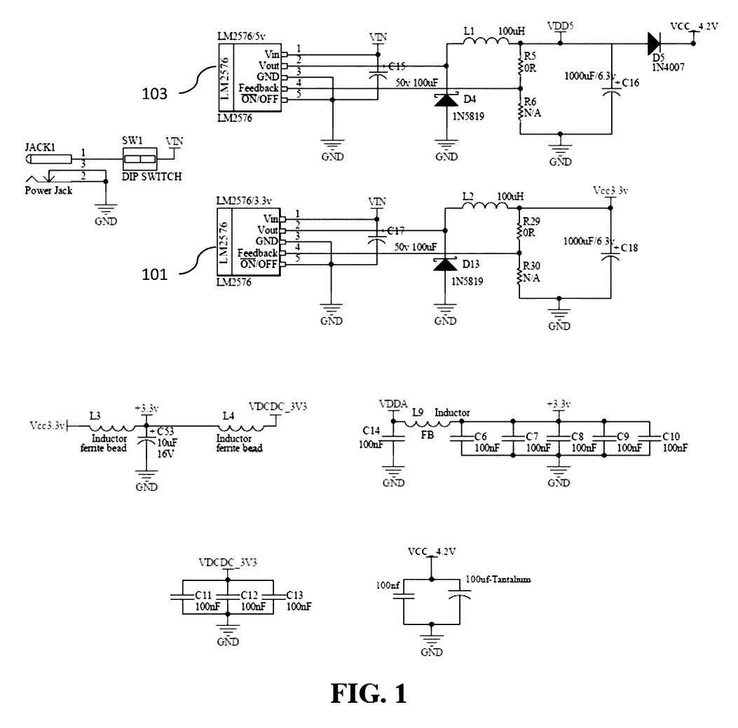

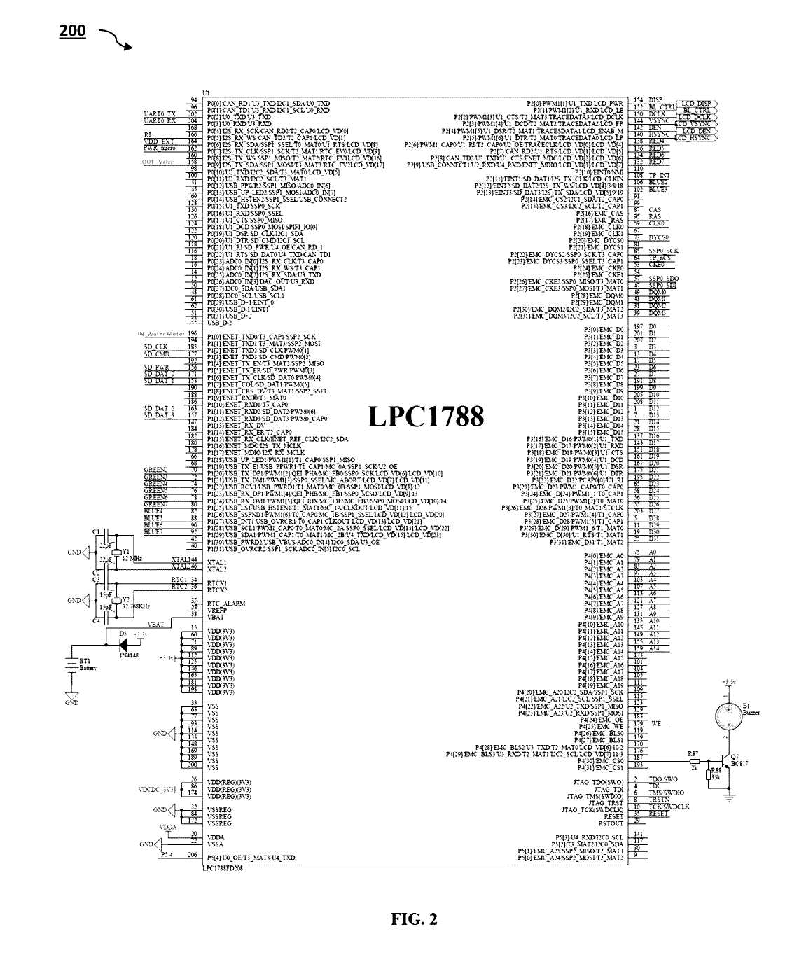

In one specific example, the system for controlling water consumption of a consumer through gamification includes a main power supply, a processing device, a display device, a memory, a data storage unit, a radio service unit, an identity module, and an electrical valve. The main power supply may be configured to produce electricity for the system located within a facility of a consumer. The main power supply is shown with respect to FIG. 1 of the instant application. The processing device may be configured to receive input data associated with water consumption of the consumer. The input data may include consumer type, meter data, date, time, and a water fee. The processing device may also be configured to calculate output data based on the received input data. The output data may include water consumption amount of the consumer, cost associated with the water consumption amount, a target consumption level for the consumer, and a consumer consumption level ranking with reference to consumption level of other consumers. The processing device is shown in FIG. 2 of the instant application.

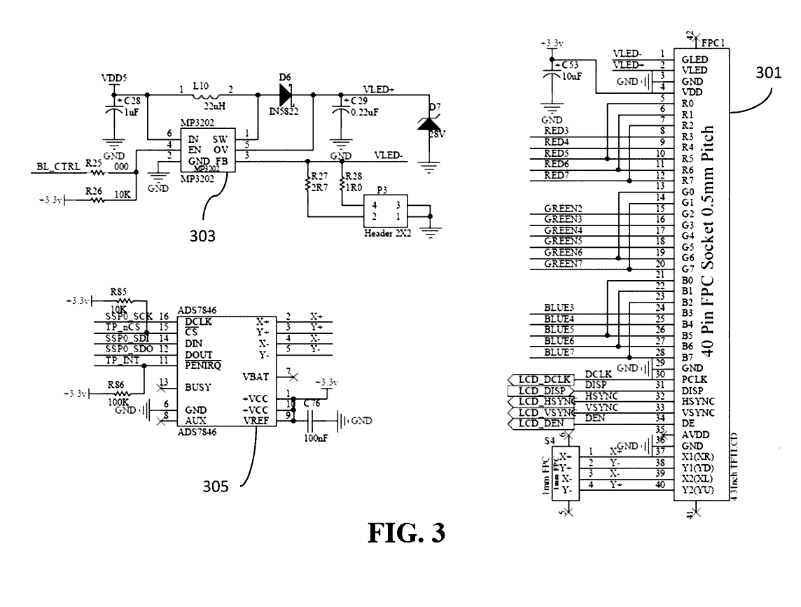

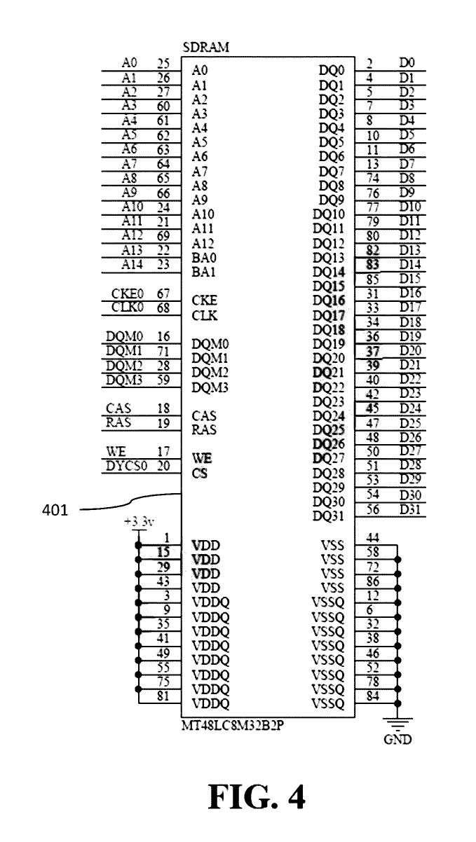

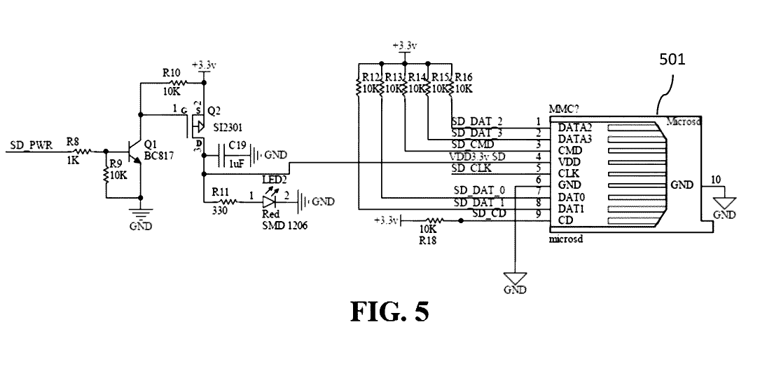

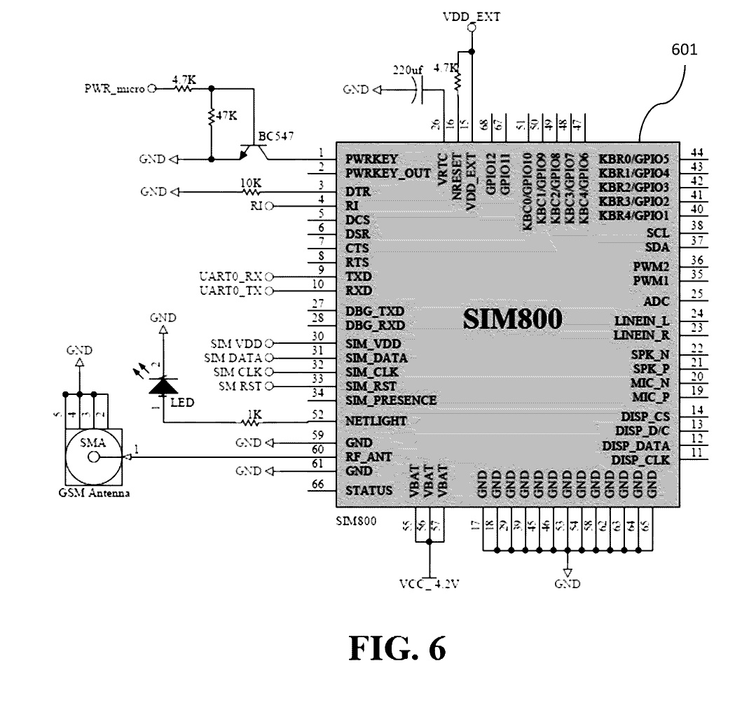

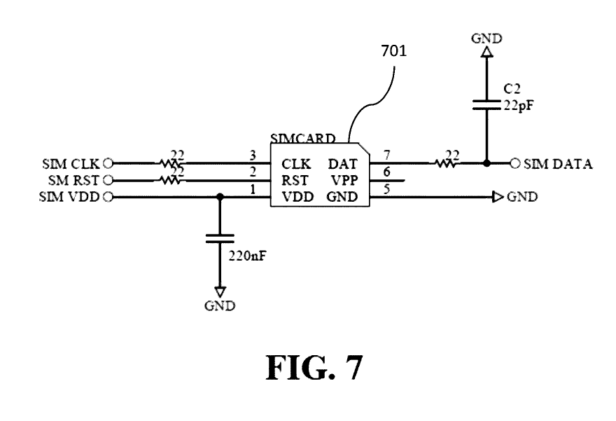

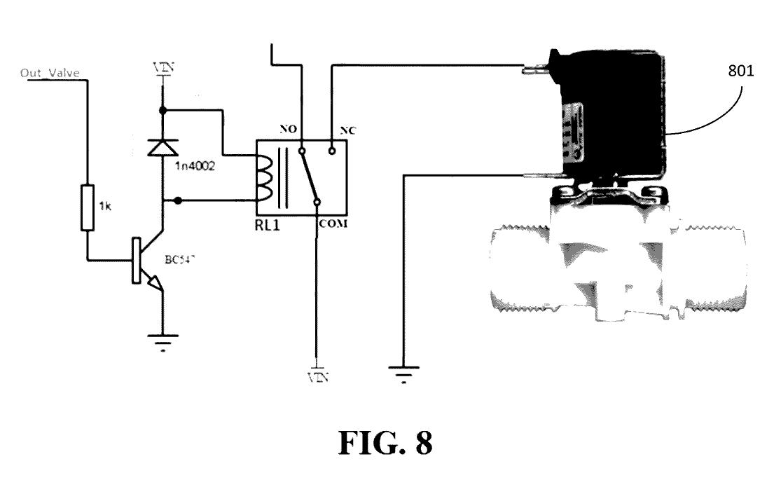

The display device may be in communication with the processing device and configured to display the output data to the consumer. The display device is shown with respect to FIG. 3 of the instant application. The memory may be in communication with the processing device and configured to temporarily store the input data and the output data. The memory is shown with respect to FIG. 4 of the instant application. The data storage unit may be in communication with the processing device and configured to permanently store the input data and the output data. The data storage unit is shown with respect to FIG. 5 of the instant application. The radio service unit may be in communication with the processing device and configured to provide communication between the system and a remote server. The radio service unit may be configured to transfer the calculated output data to the server. The radio service unit is shown with respect to FIG. 6 of the instant application. The identity module may be in communication with the processing device and configured to hold identity data of the consumer and configured to communicate the identity data to the remote server via the radio service unit. The identity module is shown with respect to FIG. 7 of the instant application. The electrical valve may be in communication with the processing device and configured to disconnect or connect water supply to the facility based on the calculated output data. The electrical valve is shown with respect to FIG. 8 of the instant application.

FIG. 1 illustrates a diagram of a power supply of an integrated system and method for changing a pattern of water consumption through gamification of a smart digital water display, according to one implementation. The integrated system and method for changing pattern of water consumption through gamification includes a set of Integrated Circuits (IC) and other electronic components that require a power supply. The power supply as shown in FIG. 1 can provide power with required voltages such as 3.3 V (Volts) DC (Direct Current), 5 V DC, etc. for the components of the integrated system and method for changing pattern of water consumption through gamification.

For example, the 3.3 V DC power can be provided by a Texas Instruments (TI) LM2576/3.3 V voltage regulator 101 shown in FIG. 1. Similarly, the 5 V DC power can be provided by a TI LM2576/5V voltage regulator 103. The regulators have a constant output respectively as 3.3 and 5 volts. The connection of the regulators 101 and 103 are shown in FIG. 1

FIG. 2 illustrates a diagram of a processor of an integrated system and method for changing a pattern of water consumption through gamification of a smart digital water display, according to one implementation. The integrated system and method for changing a pattern of water consumption through gamification, is equipped with a processing unit 200 for processing the input data such as amount of water consumption by the consumer, date, time, consumer identification data, amount of water consumption by similar consumers, etc. The processor may receive input data from a server (not shown). The server can be located at a location associated with the water authorities and connected to the integrated system and method for changing a pattern of water consumption through gamification via wired or wireless communication.

The processor 200 can process the input data and provide output data to be displayed on a display monitor (shown in FIG. 3). For example, the processor can apply various gamification calculations and statistical analysis on the input data to produce processed data to be displayed to the consumer. For example, the integrated system and method for changing a pattern of water consumption through gamification may have a software code consisting of a set of instructions stored in a memory, execution of which by the processor causing the calculations and analyses of the input data and producing of output results. The data provided to the consumer can, for example, be current water consumption, water consumption by date and month, pick consumption amount, pick consumption date and time, consumer ranking based on comparison with similar consumers consumption. Similar consumers can be, for example, similar industries, similar agricultural facilities, household with same number of members or number of members within a given range, etc. The processor may also send data to the server for further processing at the server. Alternatively, the processor may receive processed data from the server and provide the data to the consumer. For example, the processor can be a LPC1788 microcontroller. The LPC1788 has 208 legs and works based on Advanced RISC Machine (ARM) architecture. The LPC1788 is equipped with an internal Liquid Crystal Display (LCD) driver and can be used for activating color LCDs. The order and connection of the processor legs is shown in FIG. 2.

FIG. 3 illustrates a diagram of a display unit of an integrated system and method for changing a pattern of water consumption through gamification of a smart digital water display, according to one implementation. The integrated system and method for changing a pattern of water consumption through gamification can be equipped with a display monitor for displaying the output for the consumer. For example, an LCD monitor such as a 4.3 inches touch screen TFT LCD 301 can be used. This LCD has 40 legs, a back light for display in dark environments. The back light can be turned on using an auxiliary monolithic power system MP3202 component 303. In addition, the touch screen on the TFT LCD can be activated using an auxiliary ADS7846 component 305. FIG. 3 shows connection of the back light 303 and touchscreen 305 to the TFT LCD 301 and to the power supplies 101 and 103 of FIG. 1 and to the processor 200 of FIG. 2.

FIG. 4 illustrates a diagram of a dynamic memory of an integrated system and method for changing a pattern of water consumption through gamification of a smart digital water display, according to one implementation. The integrated system and method for changing a pattern of water consumption through gamification can also store the data temporarily or permanently. The data can also be stored at the server. For high-speed display of output data, data analysis results and graphs representing the data, a high-speed Synchronous Dynamic Random Access Memory (SDRAM) can be used for a temporary storage of the data. For example, an SDRAM model MT48LC8M32B2P (shown as 401 in FIG. 4) can be used. FIG. 4 illustrates connections of the SDRAM 401.

FIG. 5 illustrates a diagram of a data storage unit of an integrated system and method for changing a pattern of water consumption through gamification of a smart digital water display, according to one implementation. The integrated system and method for changing a pattern of water consumption through gamification is equipped with a permanent storage unit 501 for storing data. The integrated system and method for changing a pattern of water consumption through gamification automatically stores the input, output, and any intermittent analysis data in the data storage 501. The storage unit 501 can be an external storage to be disconnected from the integrated system and method for changing a pattern of water consumption through gamification when needed such that the information stored on the storage unit 501 can be physically transferred to a different location, when necessary. For example, in cases where online services are unavailable at the consumer location (e.g., farms) the consumption data can be manually transferred to the server by transferring the storage unit 501 from the integrated system and method for changing a pattern of water consumption through gamification to a location with available network connection (e.g., Internet).

The storage unit 501 can be a Multimedia memory Card (MMC) or a Secure Digital (SD) memory card with a capacity from 256 Megabytes (MB) to 32 Gigabytes (GB). FIG. 5 also illustrates connection between the storage unit 501 and the integrated system and method for changing a pattern of water consumption through gamification of a smart digital water display.

FIG. 6 illustrates a diagram of a radio service unit of an integrated system and method for changing a pattern of water consumption through gamification of a smart digital water display, according to one implementation. The integrated system and method for changing a pattern of water consumption through gamification can send the collected water consumption data and the calculated data to the server. For example, the data can be sent to the server using General Packet Radio Service (GPRS) technology. In this example, a Global System for Mobile communication (GSM) module SIM800, SIM900 or a similar module (shown as 601 in FIG. 6) can be used for activating the GPRS. The connection of module 601 is illustrated in FIG. 6.

FIG. 7 illustrates a diagram of connection between a radio service unit and an identity module of an integrated system and method for changing a pattern of water consumption through gamification of a smart digital water display, according to one implementation. The integrated system and method for changing a pattern of water consumption through gamification can communicate with the GPRS network using a Subscriber Identity Module (SIM) card 701 associated with a provider of the GPRS services. FIG. 7 illustrates connection of the SIM card 701 to the SIM800 module 601 of FIG. 6.

FIG. 8 illustrates a diagram of a control unit of an integrated system and method for changing a pattern of water consumption through gamification of a smart digital water display, according to one implementation. The integrated system and method for changing a pattern of water consumption through gamification can disconnect and reconnect the water supply to a consumer based on the consumer's consumption habits. The disconnecting and reconnecting of the water flow can be done using an electric valve 801. The electric valve 801 can be a 12 V DC valve placed on the water pipe. The electric valve 801 can be activated using a relay as a switch. FIG. 8 illustrates connection of the electric valve 801 to a power supply.

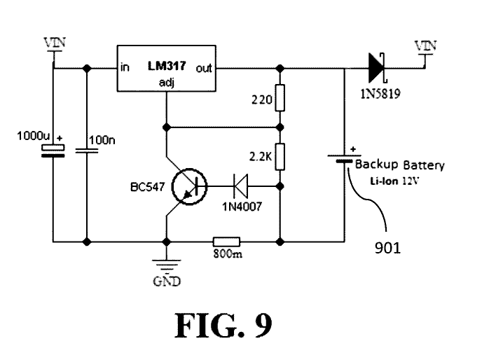

FIG. 9 illustrates a diagram of a backup battery connection for an integrated system and method for changing a pattern of water consumption through gamification of a smart digital water display, according to one implementation. The integrated system and method for changing a pattern of water consumption through gamification can be equipped with a backup battery 901 which can be automatically charged. At times when the system is connected to a main power source (e.g., electrical grid), the backup battery is charged. In case, the main electricity is disconnected, the backup battery 901 can be automatically activated and provides power to the integrated system and method for changing a pattern of water consumption through gamification. The connection of the backup battery 901 is illustrated in FIG. 9.

In addition to the components discussed above, the integrated system and method for changing a pattern of water consumption through gamification may be equipped with other components such as, for example, a printer to print the output data and/or bills on paper. The integrated system and method for changing a pattern of water consumption through gamification may also be equipped with communication capabilities such as, for example, Near-Field Communication (NFC), Bluetooth communication, etc. to send and receive data to and from personal computers and mobile devices of the consumer. The integrated system and method for changing a pattern of water consumption through gamification can also communicate with the server or with other computing devices associated with consumer accounts through a communication network (e.g., the Internet)

The integrated system and method for changing a pattern of water consumption through gamification, as described, can measure water consumption amount and the associated fees and provide the values to the consumer and to the server. For example, the consumer can be provided information via the display monitor 301 of FIG. 3. The integrated system and method for changing a pattern of water consumption through gamification enables the consumers to compare their water consumption with a standard consumption level and with an average of consumption by similar consumers. The integrated system and method for changing a pattern of water consumption through gamification enables consumers to receive consumption data from other consumers for comparison or send their consumption data to other consumers. For example, each consumption can indicate in their account with the system whether they agree to share their consumption data with other consumers. The data provided by the integrated system and method for changing a pattern of water consumption through gamification to the consumers can encourage the consumers to participate in water saving initiatives and refrain from excessive water consumption. The use of the integrated system and method for changing a pattern of water consumption through gamification can change consumer's behavioral patterns and lead to lower water consumption in the community.

In order to encourage the consumers to reduce water consumption, the water companies providing water to the consumers can use the data provided by the integrated system and method for changing a pattern of water consumption through gamification for planning and executing strategies for assigning rewards to water saving consumers and penalties to consumers with excessive water usage.

In addition, the integrated system and method for changing a pattern of water consumption through gamification can send warnings to the violating consumers and if the warnings do not help to reduce the consumer's consumption, the integrated system and method for changing a pattern of water consumption through gamification can automatically disconnect the water supply using an electrical valve 801 of FIG. 8. The number of warnings, the standard consumption level, and the period for disconnecting the water supply can be determined by the water authorities and entered as input data to the integrated system and method for changing a pattern of water consumption through gamification.

The integrated system and method for changing a pattern of water consumption through gamification, can automatically provide water consumption bills to the consumers without a need for manual reading of the water meter at the consumer location. As a result, printing paper bills can also be avoided.

In large industrial establishments, the integrated system and method for changing a pattern of water consumption through gamification can separately measure water consumption of various departments in the facility and enable the management to find the departments and activities with highest or lowest consumption.

Moreover, the water authorities can provide any announcements to the consumers using the integrated system and method for changing a pattern of water consumption through gamification, via the display monitor 301 of FIG. 3. Alternatively, the consumers can notify the water authorities of any problems in their water supply via the integrated system and method for changing a pattern of water consumption through gamification. A menu provided by the integrated system and method for changing a pattern of water consumption through gamification on the display monitor 103 can enable the consumer to send messages to the water authority. The integrated system and method for changing a pattern of water consumption through gamification can be connected to other smart water meters and exchange data with the smart water meters.

The integrated system and method for changing a pattern of water consumption through gamification can receive date and time data from the GSM network and a need for manual entry of the date can be eliminated. For remote areas where a network connection is not available, the integrated system and method for changing a pattern of water consumption through gamification can work offline and while providing the water consumption data to the consumer, store the collected water consumption data in the data storage unit 501. The integrated system and method for changing a pattern of water consumption through gamification can synchronize the locally stored data with the server, when a network connection is available. The data storage unit 501 may be portable for physical transportation of the collected data to a location with network connectivity. Alternatively, the data can be copied to a portable storage device (e.g., a USB stick) and transported to the location with network connection.

The integrated system and method for changing a pattern of water consumption through gamification is compatible with various mobile network providers and a SIM card 701 associated with an available network provider can be installed in the system. The system can be automatically

The integrated system and method for changing a pattern of water consumption through gamification can be installed in buildings, replacing the existing water meters. The integrated system and method for changing a pattern of water consumption through gamification can also be installed in agricultural facilities. The allowed level of water usage at an agricultural facility can be determined based on the type of the product, the planted area, the climate type, soil quality, etc. Using the integrated system and method for changing a pattern of water consumption through gamification, the farmers can receive feedbacks for the amount of water they consume, and the water authorities can supervise and control the water consumption levels. The integrated system and method for changing a pattern of water consumption through gamification can be also installed in industrial facilities. The allowed level of water usage at an industrial facility can be determined based on the type of the product, the production rate, the facility size, the amount of green space at the facility, etc. The competition between consumers (households, farms, industries) for reducing water consumption can reduce total consumption, prevent excessive water consumption and change consumers' behavior and community's consumption culture.

The disclosed system has various other benefits such as long distance reading of the water meters such that there is no need for an agent to visit the location and read the meter periodically. Moreover, the paper water bills can be eliminated by providing the bills to consumers through electronic means such as online accounts, emails, mobile applications, etc.

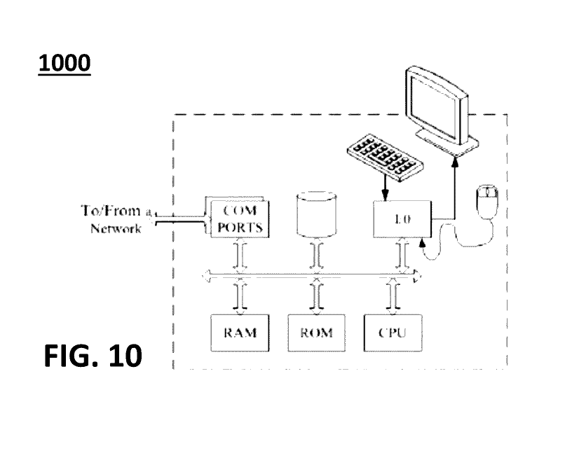

FIG. 10 is a simplified functional block diagram of an exemplary personal computer or customer device that may be used by an integrated system and method for changing a pattern of water consumption through gamification of a smart digital water display, according to an implementation. FIG. 10 depicts a computing device 1000 with user interface elements, as may be used to implement a personal computer or other type of work station, server, or terminal device. The structure, programming and general operation of such computer equipment are well known and as a result, the drawings should be self-explanatory.

A computing device, for example, includes a data communication interface for packet data communication. The computing device also includes a central processing unit (CPU), in the form of one or more processors, for executing program instructions. The computing device platform typically includes an internal communication bus, program storage and data storage for various data files to be processed and/or communicated by the computing device, although the computing device often receives programming and data via network communications. The hardware elements, operating systems, and programming languages of such computing devices are conventional in nature. Of course, the computing device functions may be implemented in a distributed fashion on a number of similar platforms, to distribute the processing load.

A computer type user terminal device, such as a PC or tablet computer, similarly includes a data communication interface CPU, main memory and one or more mass storage devices for storing user data and the various executable programs (see FIG. 10). A mobile device type user terminal may include similar elements, but will typically use smaller components that also require less power, to facilitate implementation in a portable form factor. The various types of user terminal devices will also include various user input and output elements. A computer, for example, may include a keyboard and a cursor control/selection device such as a mouse, trackball, joystick or touchpad; and a display for visual outputs. A microphone and speaker enable audio input and output. Some smartphones include similar but smaller input and output elements. Tablets and other types of smartphones utilize touch sensitive display screens, instead of separate keyboard and cursor control elements. The hardware elements, operating systems, and programming languages of such user terminal devices also are conventional in nature.

Hence, aspects of the methods of providing an integrated system and method for changing a pattern of water consumption through gamification of a smart digital water display and process outlined above may be embodied in programming. Program aspects of the technology may be thought of as “products” or “articles of manufacture” typically in the form of executable code and/or associated data that is carried on or embodied in a type of machine readable medium. “Storage” type media include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to non-transitory, tangible “storage” media, terms such as computer or machine “readable medium” refer to any medium that participates in providing instructions to a processor for execution.

Hence, a machine readable medium may take many forms, including but not limited to, a tangible storage medium, a carrier wave medium or physical transmission medium. Non-volatile storage media include, for example, optical or magnetic disks, such as any of the storage devices in any computer(s) or the like, such as may be used to implement an integrated system and method for changing a pattern of water consumption through gamification of a smart digital water display s, etc. shown in the drawings. Volatile storage media include dynamic memory, such as main memory of such a computer platform. Tangible transmission media include coaxial cables; copper wire and fiber optics, including the wires that comprise a bus within a computer system. Carrier-wave transmission media can take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a PROM and EPROM, a FLASH-EPROM, any other memory chip or cartridge, a carrier wave transporting data or instructions, cables or links transporting such a carrier wave, or any other medium from which a computer can read programming code and/or data. Many of these forms of computer readable media may be involved in carrying one or more sequences of one or more instructions to a processor for execution.

The separation of various components in the examples described above should not be understood as requiring such separation in all examples, and it should be understood that the described components and systems can generally be integrated together in a single package, or into multiple systems

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

The scope of protection is limited solely by the claims that now follow. That scope is intended and should be interpreted to be as broad as is consistent with the ordinary meaning of the language that is used in the claims when interpreted in light of this specification and the prosecution history that follows and to encompass all structural and functional equivalents. Notwithstanding, none of the claims are intended to embrace subject matter that fails to satisfy the requirement of Sections 101, 102, or 103 of the Patent Act, nor should they be interpreted in such a way. Any unintended embracement of such subject matter is hereby disclaimed.

Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various implementations for the purpose of streamlining the disclosure. This method of disclosure is not to be interpreted as reflecting an intention that the claimed implementations require more features than are expressly recited in each claim. Rather, as the following claims reflect, inventive subject matter lies in less than all features of a single disclosed implementation. Thus the following claims are hereby incorporated into the Detailed Description, with each claim standing on its own as a separately claimed subject matter.

What is claimed is:

1. A system for controlling water consumption of a consumer through gamification, the system comprising:
a main power supply configured to produce electricity for the system located within a facility of a consumer;
a processing device configured to;
receive input data associated with water consumption of the consumer, wherein the input data includes consumer type, meter data, date, time, and a water fee, and
calculate output data based on the received input data, wherein the output data includes water consumption amount of the consumer, cost associated with the water consumption amount, a target consumption level for the consumer, and a consumer consumption level ranking with reference to consumption level of other consumers;
a display device in communication with the processing device and configured to display the output data to the consumer;
a memory in communication with the processing device and configured to temporarily store the input data and the output data;
a data storage unit in communication with the processing device and configured to permanently store the input data and the output data;
a radio service unit in communication with the processing device and configured to provide communication between the system and a remote server, wherein the radio service unit is configured to transfer the calculated output data to the server;
an identity module in communication with the processing device and configured to hold identity data of the consumer and configured to communicate the identity data to the remote server via the radio service unit; and
an electrical valve in communication with the processing device and configured to disconnect or connect water supply to the facility based on the calculated output data.

2. The system of claim 1, wherein:
the processing device is further configured to compare the water consumption amount of the consumer with a threshold consumption amount and generate a warning signal if the water consumption amount of the consumer exceeds the threshold consumption amount, and
the display device is configured to display the warning signal to the consumer.

3. The system of claim 2, wherein:
the processing device is further configured to monitor a total number of warning signals generated by the processing device, compare the total number of the warning signals with a threshold number, and generate a control signal if the total number of the warning signals exceeds the threshold number,
the electrical valve is configured to receive the control signal and disconnect the water supply to the facility based on the control signal.

4. The system of claim 3, further comprising a backup battery configured to produce electricity for the system when the main power supply is unavailable, wherein the main power supply includes an electrical grid.

5. The system of claim 4, wherein the display device includes a touch screen display device enabling the consumer to interact with the system.

6. The system of claim 4, wherein:
the processing device is configured to receive the target consumption level from the remote server, and
the target consumption level being determined based on a lowest consumption level of other consumers being of the same type as the consumer and set to enable competition between the consumer and the other consumers to preserve water consumption.

7. The system of claim 6, wherein the consumer type includes a household, an industry, an agricultural facility, or a combination thereof.

8. The system of claim 7, wherein:
the radio service unit is configured to provide wireless communication between the system and the remote server,
the processing device is configured to receive water consumption levels of the other consumers from the remote server through the radio service unit, and
the display device is configured to display the water consumption levels of other consumers.

9. The system of claim 8, wherein the output data is provided to the consumer via the display device in real time.

10. The system of claim 8, wherein the radio service unit sends the input data, the output data or a combination thereof to the remote server.

11. The system of claim 1, wherein the processing device is further configured to generate a warning of excessive water consumption based on the input data, the output data, or a combination thereof, and send the warning to the consumer via the display device.

12. The system of claim 1, wherein the data storage unit is external to the system.

13. A method for changing pattern of water consumption of a consumer through gamification, the method comprising:
receiving via a processing device input data associated with water consumption of the consumer, wherein the input data includes consumer type, meter data, date, time, and a water fee;
calculating via the processing device output data based on the received input data, wherein the output data includes water consumption amount of the consumer, cost associated with the water consumption amount, a target consumption level for the consumer, and consumption level of other consumers similar to the consumers;
displaying via a display device the output data to the consumer;
storing in a data storage unit the input data, the output data or a combination thereof; and
sending via a radio service unit the input data, the output data or a combination thereof to a remote server,
wherein the target consumption level is determined based on a lowest consumption level of the other consumers and is set to enable competition between the consumer and the other consumers to preserve water consumption.

14. The method of claim 13, further comprising:
comparing via the processing device the water consumption amount of the consumer with a threshold consumption amount;
generating via the processing device a warning signal if the water consumption amount of the consumer exceeds the threshold consumption amount; and
displaying via the display device the warning signal to the consumer.

15. The method of claim 13, further comprising:
monitoring a total number of warning signals generated by the processing device;
comparing via the processing device the total number of the warning signals with a threshold number; and
generating a control signal if the total number of the warning signals exceeds the threshold number.

16. The method of claim 15, further comprising:
sending via the processing device the control signal to an electrical valve; and
disconnecting via the electrical valve a water supply to a facility based on the control signal.

17. The method of claim 16, wherein the consumer type includes a household, an industry, an agricultural facility, or a combination thereof.

18. The method of claim 16, further comprising displaying via the display device the consumption levels of other consumers similar to the consumers based on a permission received from other consumers.

19. The method of claim 13, wherein display the output data includes display via the display device the output data to the consumer in real time.
